(19) United States
(12) Patent Application Publication
(10) Pub. No.: US 2016/0314740 A1
(43) Pub. Date: Oct. 27, 2016

(54) AMOLED PIXEL DRIVING CIRCUIT AND PIXEL DRIVING METHOD

(71) Applicant: Shenzhen China Star Optoelectronics Technology Co. Ltd., Shenzhen City (CN)

(72) Inventor: Xiaoling WU, Shenzhen City (CN)

(21) Appl. No.: 14/655,739

(22) PCT Filed: Apr. 1, 2015
(86) PCT No.: PCT/CN2015/075689

§ 371 Date: Jun. 26, 2015

(30) Foreign Application Priority Data
Feb. 3, 2015 (CN) 201510057226.X

(51) Int. Cl. G09G 3/3258; G09G 3/3291

(52) U.S. Cl. CPC G09G 3/3258; G09G 3/3291; G09G 2300/043; G09G 2300/0426; G09G 2320/0233; G09G 2330/021; G09G 2300/0819

(57) ABSTRACT

The present invention provides an AMOLED pixel driving circuit and a pixel driving method. The AMOLED pixel driving circuit comprises a first, a second, a third, a fourth and a fifth thin film transistors (T1, T2, T3, T4, T5), a capacitor (C1) and an organic light emitting diode (D1). The first thin film transistor and the second thin film transistor (T1, T2) are symmetrically located, and the threshold voltages are equal, which can compensate the threshold voltage of the drive thin film transistor; the fifth thin film transistor (T5) is located between the power supply voltage (Vdd) and the first thin film transistor (T1), i.e. the drive thin film transistor, and the third scan control signal (S3) is employed to control the fifth thin film transistor (T5) to be activated only in the drive stage (3) according to the time sequence. Thus, the organic light emitting diode (D1) is controlled to emit light only in the drive stage (3) to avoid the unnecessary irradiance of the organic light emitting diode (D1) to reduce the electrical power consumption and improve the display effect of the pictures.

### FIELD OF THE INVENTION

The present invention relates to a display technology field, and more particularly to a method of compensating AMOLED power supply voltage drop.

### BACKGROUND OF THE INVENTION

The Organic Light Emitting Display (OLED) possesses many outstanding properties of self-illumination, low driving voltage, high luminescence efficiency, short response time, high clarity and contrast, near 180° view angle, wide range of working temperature, applicability of flexible display and large scale full color display. The OLED is considered as the most potential display device. The OLED can be categorized into two major types according to the driving methods, which are the Passive Matrix OLED (PMOLED) and the Active Matrix OLED (AMOLED), i.e. two types of the direct addressing and the Thin Film Transistor (TFT) matrix addressing. The AMOLED comprises pixels arranged in array and belongs to active display type, which has high lighting efficiency and is generally utilized for the large scale display devices of high resolution.

The AMOLED is a current driving element. When the electrical current flows through the organic light emitting diode, the organic light emitting diode emits light, and the brightness is determined according to the current flowing through the organic light emitting diode itself. Most of the present Integrated Circuits (IC) only transmit voltage signals. Therefore, the AMOLED pixel driving circuit needs to accomplish the task of converting the voltage signals into the current signals. Because the threshold voltage of the drive thin film transistor will drift along with time to cause the unstable irradiance of the organic light emitting diode to affect the display effect. The AMOLED pixel driving circuit still needs to be equipped with function of compensating the threshold voltage of the drive thin film transistor.

As shown in FIG. 1, which is an AMOLED pixel driving circuit according to prior art is shown. The AMOLED pixel driving circuit has a 4T1C structure, i.e. a structure of four thin film transistors and one capacitor, comprising a first thin film transistor T10, a second thin film transistor T20, a third thin film transistor T30, a fourth thin film transistor T40 and a capacitor C10; wherein a gate of the first thin film transistor T10 is electrically coupled to a gate of the second thin film transistor T20 via a first node A0, and a drain is electrically coupled to a power supply voltage Vdd, and a source is electrically coupled to an anode of the organic light emitting diode D10; a gate of the second thin film transistor T20 is electrically coupled to the gate of the first thin film transistor T10 via the first node A0, and a drain is electrically coupled to a drain of the third thin film transistor T30 and the first node A0, and a source is electrically coupled to a drain of the fourth thin film transistor T40; a gate of the third thin film transistor T30 is electrically coupled to a first scan control signal S10, and a source is electrically coupled to a power supply voltage Vdd, and the drain is electrically coupled to the drain of the second thin film transistor T20 and the first node A0; a gate of the fourth thin film transistor T40 is electrically coupled to a second scan control signal S20, and a source is electrically coupled to a data signal Data, and a drain is electrically coupled to the source of the second thin film transistor T20; one end of the capacitor C10 is electrically coupled to the first node A0, and the other end is grounded; the anode of the organic light emitting diode D10 is electrically coupled to the source of the first thin film transistor T10, and a cathode is grounded.

FIG. 2 is a sequence diagram corresponding to the circuit shown in FIG. 1. The working procedure of the circuit is divided into three stages according to time sequence: a pre-adjustment stage 10, a current adjustment stage 20 and a drive stage 30. With conjunction of FIG. 2, FIG. 3, in the pre-adjustment stage 10, the first scan control signal S10 provides high voltage level, and the third thin film transistor T30 is activated, and both the second scan control signal S20 and the data signal Data provide low voltage level, and the fourth thin film transistor T40 is deactivated, and the capacitor C10 is charged to the power supply voltage Vdd, and a gate voltage Vg of the first thin film transistor T10 is raised to the power supply voltage Vdd, and the first thin film transistor T10 is activated, and the drain voltage Vd of the first thin film transistor T10 is equal to the power supply voltage Vdd, and the organic light emitting diode D10 emits light. Significantly, in the pre-adjustment stage 10, because the gate voltage Vg of the first thin film transistor T10 is higher, the current flowing through the organic light emitting diode D10 is larger; with conjunction of FIG. 2, FIG. 4, in the current adjustment stage 20, the first scan control signal S10 provides high voltage level, and the third thin film transistor T30 is activated, and the second scan control signal S20 and the data signal Data provide high voltage level, and the fourth thin film transistor T40 is activated, and the capacitor C10 is discharged to V_{Data}+V_{Th20}, and the gate voltage Vg of the first thin film transistor T10 is correspondingly converted to V_{Data}+V_{Th20}, wherein V_{Data} is a voltage provided by the data signal Data, and V_{Th20} is a threshold voltage of the second thin film transistor T20, and the first thin film transistor T10 is activated, and the drain voltage Vd of the first thin film transistor T10 is equal to the power supply voltage Vdd, and the organic light emitting diode D10 emits light; with conjunction of FIG. 2, FIG. 5, in the drive stage 30, all of the first scan control signal S10, the second scan control signal S20 and the data signal Data provide low voltage, and the third, the fourth thin film transistors T30, T40 are deactivated, and under the function of the capacitor C10, the first thin film transistor T10 remains to be activated, and the drain voltage Vd of the first thin film transistor T10 is equal to the power supply voltage Vdd, and the organic light emitting diode D10 emits light.

The first, the second thin film transistors T10, T20 are symmetrically located, and the mirror structure is utilized. Thus, V_{Th10}=V_{Th20}, wherein the V_{Th10} is the threshold voltage of the first thin film transistor T10. In the drive stage 30, the gate voltage Vg of the first thin film transistor T10 is: Vg=V_{Data}+V_{Th20}, and the source voltage Vs of the first thin film transistor T10 is: Vs=V_{OLED}, wherein V_{OLED} is the threshold voltage of the organic light emitting diode D10. According to the current property equation of the thin film transistor in this field, the current I_{OLED} flowing through the organic light emitting diode D10 is:

$$\begin{matrix}{I}_{OLED} = {K ( Vg - Vs - {V}_{Th 10} )}^{2} \\ = {K ( {V}_{Data} + {V}_{Th 20} - {V}_{OLED} - {V}_{Th 10} )}^{2} \\ = {K ( {V}_{Data} - {V}_{OLED} )}^{2}\end{matrix}$$

wherein K is the structure parameter of the thin film transistor. As regarding the thin film transistors having the same structure, K is relatively stable. As known from the equation, the current I_{OLED} flowing through the organic light emitting diode D10 is irrelevant with the threshold voltage V_{Th10} of the first thin film transistor T10. The compensation works. Although the present AMOLED pixel driving circuit achieves the threshold voltage compensation. However, in either of the pre-adjustment stage 10, the current adjustment stage 20 and the drive stage, the irradiance occurs. In the re-adjustment stage 10, the current adjustment stage 20, the irradiance is not necessary. Particularly in the pre-adjustment stage 10, the current flowing through the organic light emitting diode D10 is larger. As shown in FIG. 6, the current can be high to reach up dozens of microamperes, which consumes the power and influences the display effect of the pictures.

### SUMMARY OF THE INVENTION

An objective of the present invention is to provide an AMOLED pixel driving circuit, which can compensate the threshold voltage of the drive thin film transistor, and avoid the unnecessary irradiance of the organic light emitting diode to reduce the electrical power consumption and improve the display effect of the pictures.

Another objective of the present invention is to provide an AMOLED pixel driving method, which solves the issue of the unnecessary irradiance of the organic light emitting diode, electrical power consumption and influence to the display effect of the pictures as compensating the threshold voltage of the drive thin film transistor.

For realizing the aforesaid objectives, the present invention first provides an AMOLED pixel driving circuit, comprising: a first thin film transistor, a second thin film transistor, a third thin film transistor, a fourth thin film transistor, a fifth thin film transistor, a capacitor and an organic light emitting diode;

a gate of the first thin film transistor is electrically coupled to a gate of the second thin film transistor via a first node, and a drain is electrically coupled to a drain of the fifth thin film transistor, and a source is electrically coupled to an anode of the organic light emitting diode;

the gate of the second thin film transistor is electrically coupled to the gate of the first thin film transistor via the first node, and a drain is electrically coupled to a drain of the third thin film transistor and the first node, and a source is electrically coupled to a drain of the fourth thin film transistor;

a gate of the third thin film transistor is electrically coupled to a first scan control signal, and a source is electrically coupled to a power supply voltage, and the drain is electrically coupled to the drain of the second thin film transistor and the first node;

a gate of the fourth thin film transistor is electrically coupled to a second scan control signal, and a source is electrically coupled to a data signal, and a drain is electrically coupled to the source of the second thin film transistor;

a gate of the fifth thin film transistor is electrically coupled to a third scan control signal, and a source is electrically coupled to the power supply voltage and a drain is electrically coupled to the drain of the first thin film transistor;

one end of the capacitor is electrically coupled to the first node, and the other end is grounded;

the anode of the organic light emitting diode is electrically coupled to the source of the first thin film transistor, and a cathode is grounded;

the first thin film transistor is a drive thin film transistor, and a threshold voltage thereof is equal to a threshold voltage of the second thin film transistor;

the third scan control signal provides high, low alternate voltages according to time sequence to control whether the organic light emitting diode emits light or not.

All of the first thin film transistor, the second thin film transistor, the third thin film transistor, the fourth thin film transistor and the fifth thin film transistor are Low Temperature Poly-silicon thin film transistors, oxide semiconductor thin film transistors or amorphous silicon thin film transistors.

The first thin film transistor and the second thin film transistor are symmetrically located, and widths of channels of the two are similar.

All of the first scan control signal, the second scan control signal and the third scan control signal are provided by an external sequence controller.

The first scan control signal, the second scan control signal, the third scan control signal and the data signal are combined with one another, and correspond to a pre-adjustment stage, a current adjustment stage and a drive stage one after another;

the third scan control signal provides low voltage level in both the pre-adjustment stage and the current adjustment stage to control the organic light emitting diode not to emit light; the third scan control signal provides high voltage level in the drive stage to control the organic light emitting diode to emit light.

in the pre-adjustment stage, the first scan control signal provides high voltage level, and all of the second scan control signal, the third scan control signal and the data signal provide low voltage level;

in the current adjustment stage, both the first scan control signal and the third scan control signal provide low voltage level, and both the second scan control signal and the data signal provide high voltage level;

in the drive stage, all of the first scan control signal, the second scan control signal and the data signal provide low voltage level, and the third scan control signal provides high voltage level.

The present invention further provides an AMOLED pixel driving circuit, comprising: a first thin film transistor, a second thin film transistor, a third thin film transistor, a fourth thin film transistor, a fifth thin film transistor, a capacitor and an organic light emitting diode;

a gate of the first thin film transistor is electrically coupled to a gate of the second thin film transistor via a first node, and a drain is electrically coupled to a drain of the fifth thin film transistor, and a source is electrically coupled to an anode of the organic light emitting diode;

the gate of the second thin film transistor is electrically coupled to the gate of the first thin film transistor via the first node, and a drain is electrically coupled to a drain of the third thin film transistor and the first node, and a source is electrically coupled to a drain of the fourth thin film transistor;

a gate of the third thin film transistor is electrically coupled to a first scan control signal, and a source is electrically coupled to a power supply voltage, and the drain is electrically coupled to the drain of the second thin film transistor and the first node;

a gate of the fourth thin film transistor is electrically coupled to a second scan control signal, and a source is electrically coupled to a data signal, and a drain is electrically coupled to the source of the second thin film transistor;

a gate of the fifth thin film transistor is electrically coupled to a third scan control signal, and a source is electrically coupled to the power supply voltage and a drain is electrically coupled to the drain of the first thin film transistor;

one end of the capacitor is electrically coupled to the first node, and the other end is grounded;

the anode of the organic light emitting diode is electrically coupled to the source of the first thin film transistor, and a cathode is grounded;

the first thin film transistor is a drive thin film transistor, and a threshold voltage thereof is equal to a threshold voltage of the second thin film transistor;

the third scan control signal provides high, low alternate voltages according to time sequence to control whether the organic light emitting diode emits light or not;

wherein all of the first thin film transistor, the second thin film transistor, the third thin film transistor, the fourth thin film transistor and the fifth thin film transistor are Low Temperature Poly-silicon thin film transistors, oxide semiconductor thin film transistors or amorphous silicon thin film transistors;

wherein the first thin film transistor and the second thin film transistor are symmetrically located, and widths of channels of the two are similar.

Specifically, the working procedure of the AMOLED pixel circuit according to the present invention comprises stages of:

step 1, providing an AMOLED pixel driving circuit;

the AMOLED pixel driving circuit comprises: a first thin film transistor, a second thin film transistor, a third thin film transistor, a fourth thin film transistor, a fifth thin film transistor, a capacitor and an organic light emitting diode;

a gate of the first thin film transistor is electrically coupled to a gate of the second thin film transistor via a first node, and a drain is electrically coupled to a drain of the fifth thin film transistor, and a source is electrically coupled to an anode of the organic light emitting diode;

the gate of the second thin film transistor is electrically coupled to the gate of the first thin film transistor via the first node, and a drain is electrically coupled to a drain of the third thin film transistor and the first node, and a source is electrically coupled to a drain of the fourth thin film transistor;

a gate of the third thin film transistor is electrically coupled to a first scan control signal, and a source is electrically coupled to a power supply voltage, and the drain is electrically coupled to the drain of the second thin film transistor and the first node;

a gate of the fourth thin film transistor is electrically coupled to a second scan control signal, and a source is electrically coupled to a data signal, and a drain is electrically coupled to the source of the second thin film transistor;

a gate of the fifth thin film transistor is electrically coupled to a third scan control signal, and a source is electrically coupled to the power supply voltage and a drain is electrically coupled to the drain of the first thin film transistor;

one end of the capacitor is electrically coupled to the first node, and the other end is grounded;

the anode of the organic light emitting diode is electrically coupled to the source of the first thin film transistor, and a cathode is grounded;

the first thin film transistor is a drive thin film transistor, and a threshold voltage thereof is equal to a threshold voltage of the second thin film transistor;

step 2, entering a pre-adjustment stage;

the first scan control signal provides high voltage level, and both the second scan control signal and the data signal provide low voltage level, and the capacitor is charged to the power supply voltage, and a gate voltage of the first thin film transistor is raised to the power supply voltage, and the first thin film transistor is activated, and the third scan control signal provides low voltage level, and the fifth thin film transistor is deactivated to control the organic light emitting diode not to emit light;

step 3, entering a current adjustment stage;

the first scan control signal provides low voltage level, and both the second scan control signal and the data signal provide high voltage level, and the capacitor is discharged to V_{Data}+V_{Th2}, and the gate voltage of the first thin film transistor is correspondingly converted to V_{Data}+V_{Th2}, wherein V_{Data} is a voltage provided by the data signal Data, and V_{Th2} is a threshold voltage of the second thin film transistor, and the first thin film transistor is activated, and the third scan control signal provides low voltage level, and the fifth thin film transistor is deactivated to control the organic light emitting diode not to emit light;

step 4, entering a drive stage;

all of the first scan control signal, the second scan control signal and the data signal provide low voltage level, and the gate voltage of the first thin film transistor remains to be V_{Data}+V_{Th2}, and the first thin film transistor is activated, and the third scan control signal provides high voltage level, and the fifth thin film transistor is activated to control the organic light emitting diode to emit light, and the threshold voltage of the second thin film transistor compensates the threshold voltage of the first thin film transistor to make a current flowing through the organic light emitting diode irrelevant with the threshold voltage of the first thin film transistor.

All of the first thin film transistor, the second thin film transistor, the third thin film transistor, the fourth thin film transistor and the fifth thin film transistor are Low Temperature Poly-silicon thin film transistors, oxide semiconductor thin film transistors or amorphous silicon thin film transistors.

All of the first scan control signal, the second scan control signal and the third scan control signal are provided by an external sequence controller.

The first thin film transistor and the second thin film transistor are symmetrically located, and widths of channels of the two are similar.

The benefits of the present invention are: an AMOLED pixel driving circuit and pixel driving method provided by the present invention, by symmetrically locating the first thin film transistor and the second thin film transistor, of which the threshold voltages are equal, realizes the function of compensating the threshold voltage of the drive thin film transistor to make a current flowing through the organic light emitting diode irrelevant with the threshold voltage of the first thin film transistor; the fifth thin film transistor is located between the power supply voltage and the first thin film transistor, i.e. the drive thin film transistor, and the third scan control signal is employed to control the fifth thin film transistor to be activated only in the drive stage according to the time sequence. Thus, the organic light emitting diode is controlled to emit light only in the drive stage to avoid the unnecessary irradiance of the organic light emitting diode to reduce the electrical power consumption and improve the display effect of the pictures.

In order to better understand the characteristics and technical aspect of the invention, please refer to the following detailed description of the present invention is concerned with the diagrams, however, provide reference to the accompanying drawings and description only and is not intended to be limiting of the invention.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a circuit diagram of an AMOLED pixel driving circuit according to prior art;

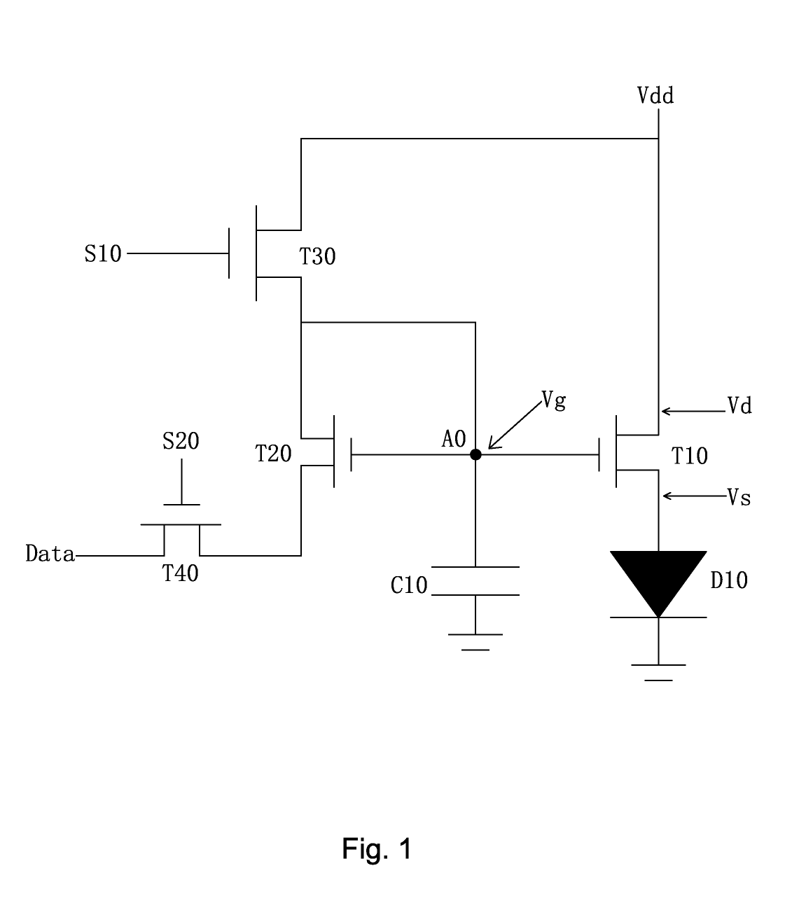

FIG. 2 is a sequence diagram of an AMOLED pixel driving circuit shown in FIG. 1;

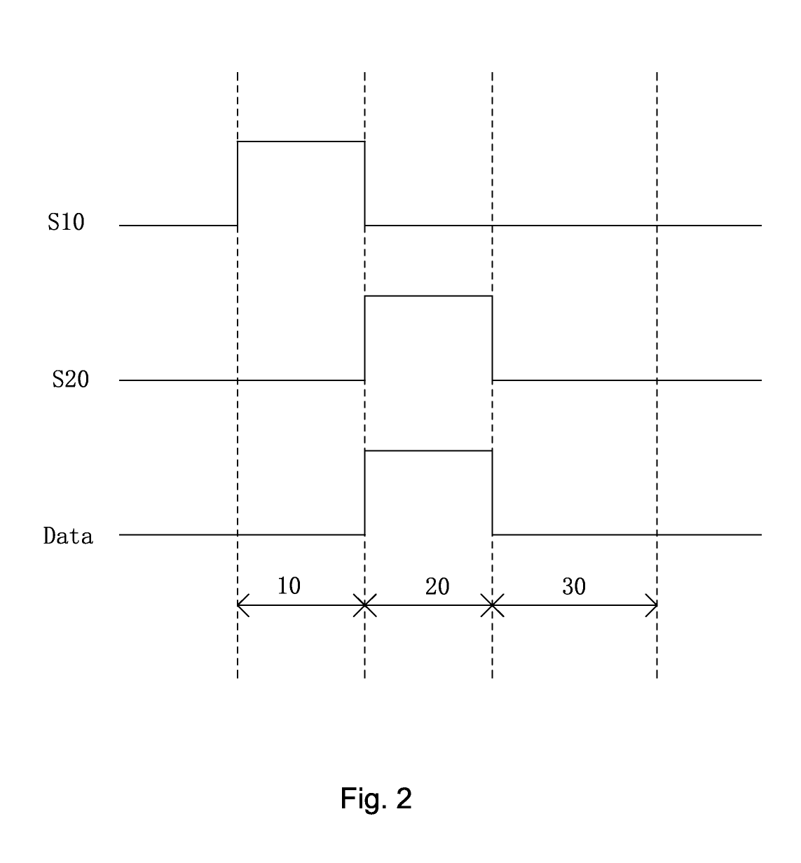

FIG. 3 is a circuit diagram of an AMOLED pixel driving circuit shown in FIG. 1 to be in a pre-adjustment stage;

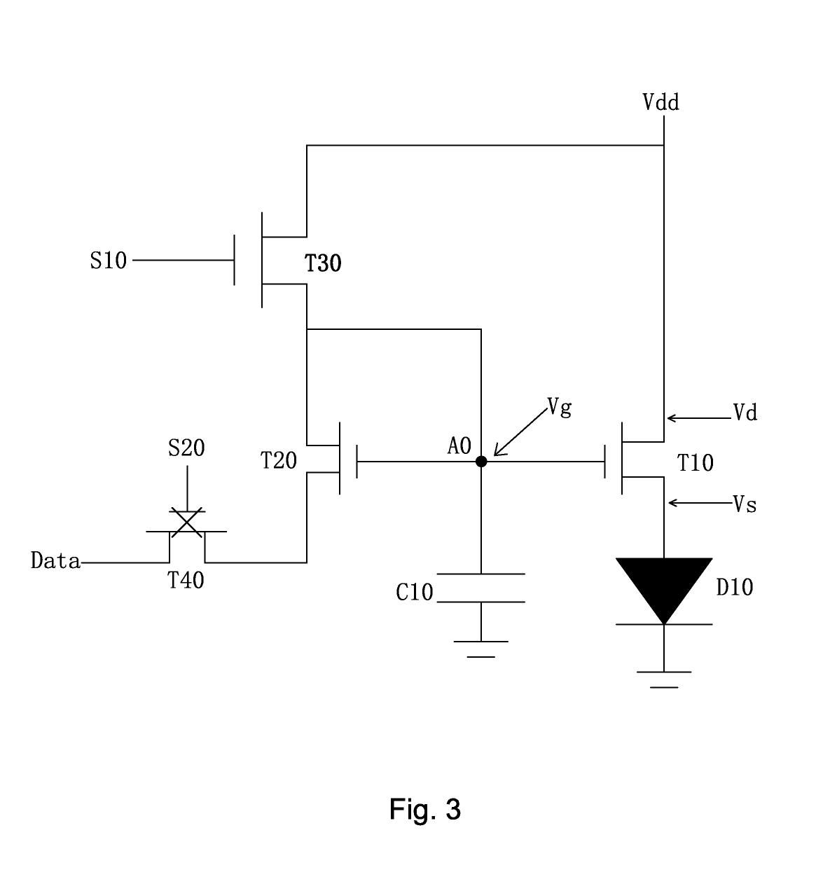

FIG. 4 is a circuit diagram of an AMOLED pixel driving circuit shown in FIG. 1 to be in a current adjustment stage;

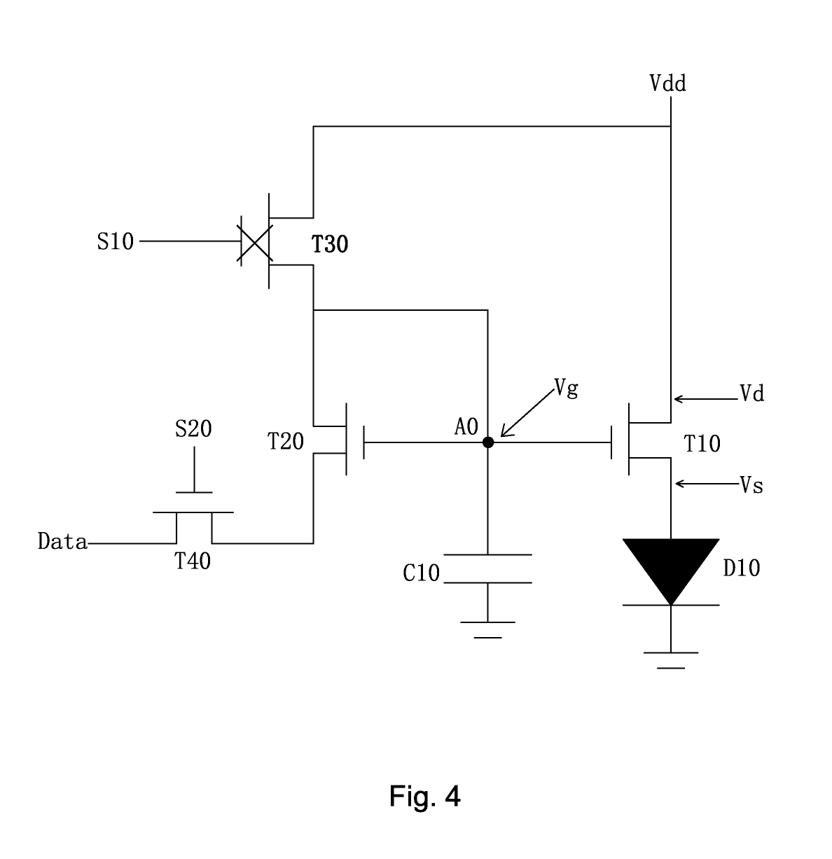

FIG. 5 is a circuit diagram of an AMOLED pixel driving circuit shown in FIG. 1 to be in a drive adjustment stage;

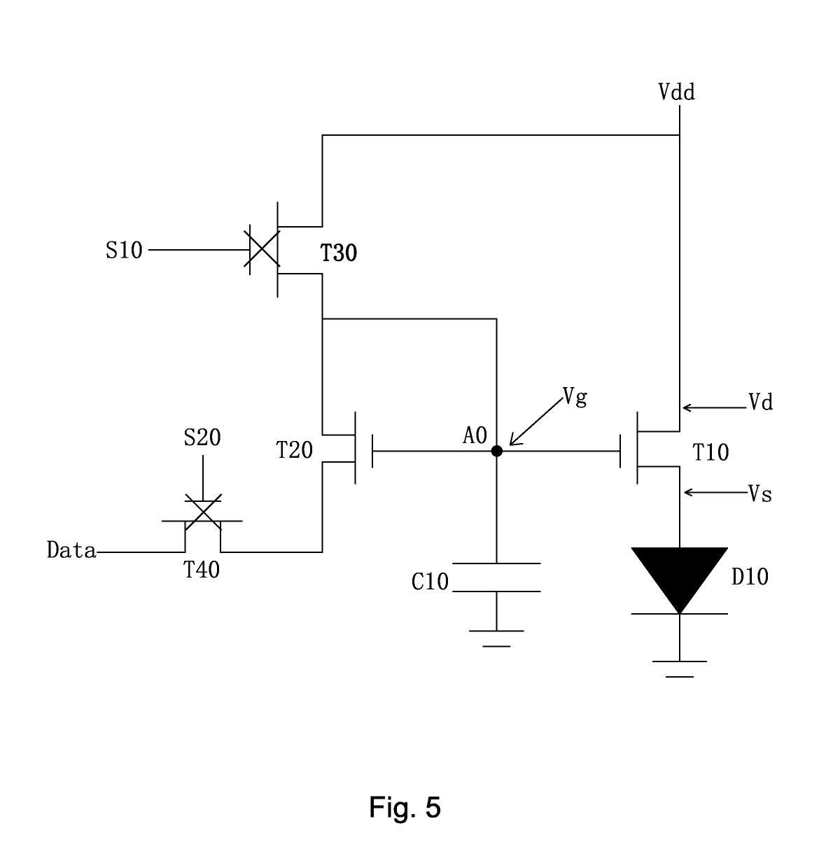

FIG. 6 is a simulation diagram of the current flowing through the organic light emitting diode under different gate voltages in the AMOLED pixel driving circuit shown in FIG. 1;

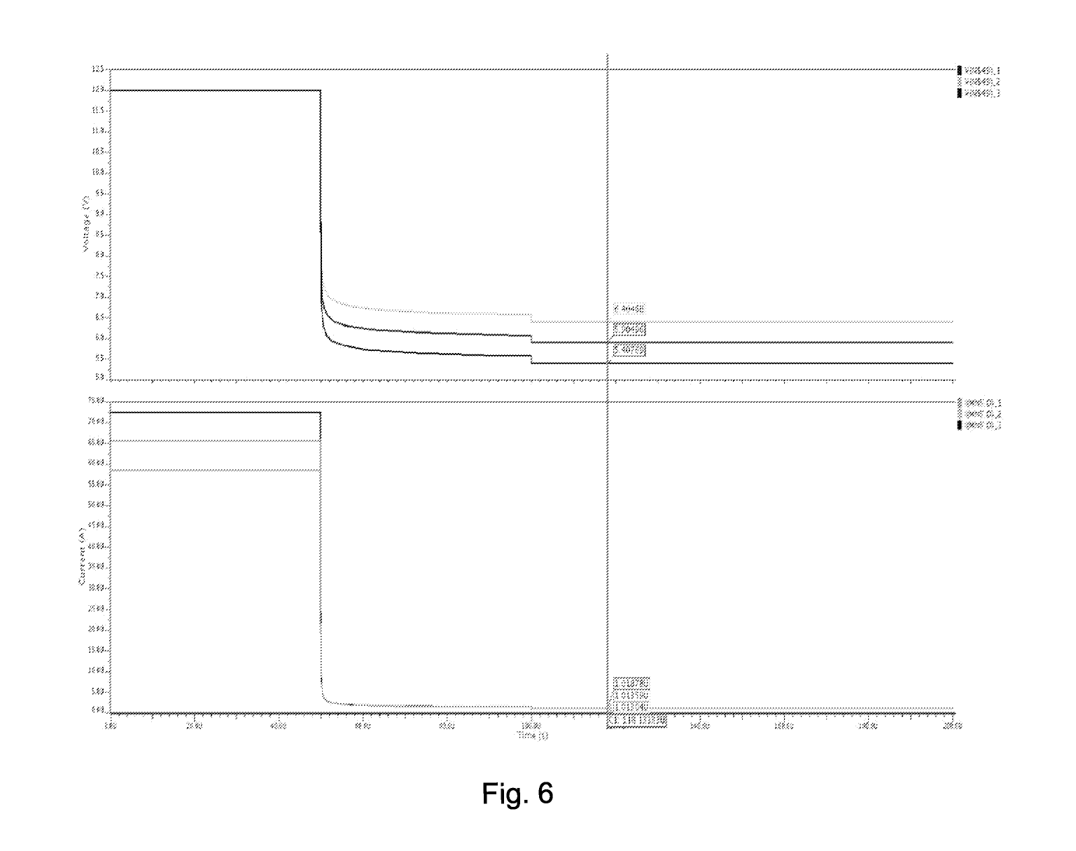

FIG. 7 is a circuit diagram of an AMOLED pixel driving circuit according to present invention;

FIG. 8 is a sequence diagram of an AMOLED pixel driving circuit shown in FIG. 7;

FIG. 9 is a circuit diagram of an AMOLED pixel driving circuit shown in FIG. 7 to be in a pre-adjustment stage, and also a circuit diagram of the step 2 in the AMOLED pixel driving method according to the present invention;

FIG. 10 is a circuit diagram of an AMOLED pixel driving circuit shown in FIG. 7 to be in a current adjustment stage, and also a circuit diagram of the step 3 in the AMOLED pixel driving method according to the present invention;

FIG. 11 is a circuit diagram of an AMOLED pixel driving circuit shown in FIG. 7 to be in a drive stage, and also a circuit diagram of the step 4 in the AMOLED pixel driving method according to the present invention;

FIG. 12 is a simulation diagram of the current flowing through the organic light emitting diode under different gate voltages in the AMOLED pixel driving circuit shown in FIG. 7.

### DETAILED DESCRIPTION OF PREFERRED EMBODIMENTS

For better explaining the technical solution and the effect of the present invention, the present invention will be further described in detail with the accompanying drawings and the specific embodiments.

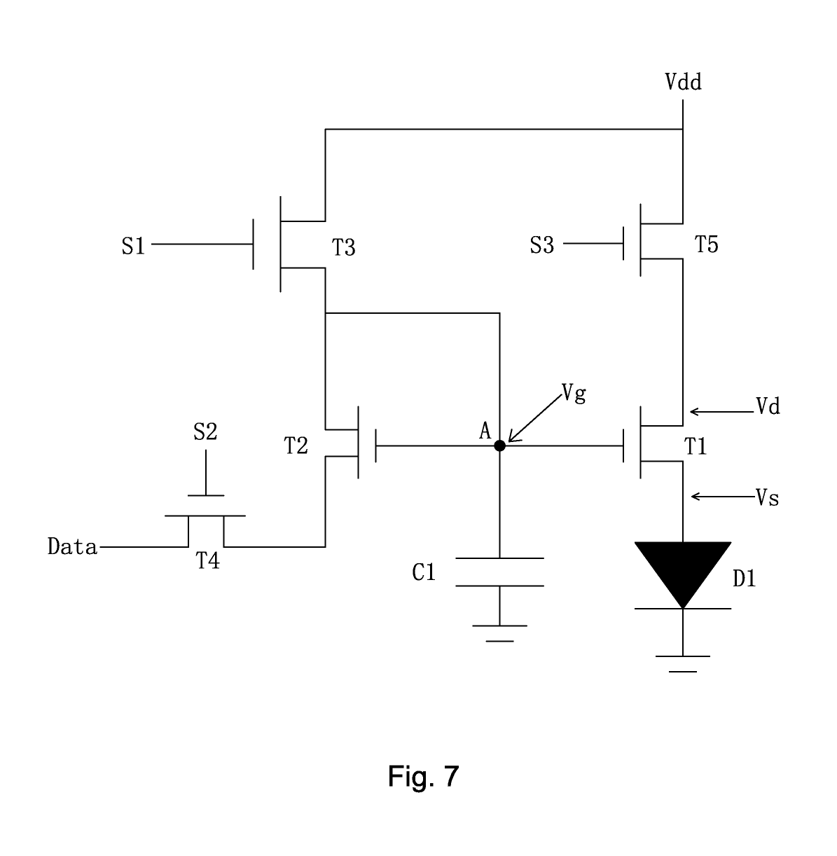

Please refer to FIG. 7. The present invention provides an AMOLED pixel driving circuit, and the AMOLED pixel driving circuit utilizes a 5T1C structure, and comprises: a first thin film transistor T1, a second thin film transistor T2, a third thin film transistor T3, a fourth thin film transistor T4, a fifth thin film transistor T5, a capacitor C1 and an organic light emitting diode D1. A gate of the first thin film transistor T1 is electrically coupled to a gate of the second thin film transistor T2 via a first node A, and a drain is electrically coupled to a drain of the fifth thin film transistor T5, and a source is electrically coupled to an anode of the organic light emitting diode D1; the gate of the second thin film transistor T2 is electrically coupled to the gate of the first thin film transistor T1 via the first node A, and a drain is electrically coupled to a drain of the third thin film transistor T3 and the first node A, and a source is electrically coupled to a drain of the fourth thin film transistor T4; a gate of the third thin film transistor T3 is electrically coupled to a first scan control signal S1, and a source is electrically coupled to a power supply voltage Vdd, and the drain is electrically coupled to the drain of the second thin film transistor T2 and the first node A; a gate of the fourth thin film transistor T4 is electrically coupled to a second scan control signal S2, and a source is electrically coupled to a data signal Data, and a drain is electrically coupled to the source of the second thin film transistor T2; a gate of the fifth thin film transistor T5 is electrically coupled to a third scan control signal S3, and a source is electrically coupled to the power supply voltage Vdd and a drain is electrically coupled to the drain of the first thin film transistor T1; one end of the capacitor C1 is electrically coupled to the first node A, and the other end is grounded; the anode of the organic light emitting diode D1 is electrically coupled to the source of the first thin film transistor T1, and a cathode is grounded.

Specifically, all of the first thin film transistor T1, the second thin film transistor T2, the third thin film transistor T3, the fourth thin film transistor T4 and the fifth thin film transistor T5 are Low Temperature Poly-silicon thin film transistors, oxide semiconductor thin film transistors or amorphous silicon thin film transistors. The first thin film transistor T1 and the second thin film transistor T2 are symmetrically located, and widths of channels of the two are similar. Accordingly, the threshold voltages of the first thin film transistor T1 and the second thin film transistor T2 are approximately equal, and the threshold voltage of the second thin film transistor T2 can compensate the threshold voltage of the first thin film transistor T1, i.e. the drive thin film transistor to make a current flowing through the organic light emitting diode D1 irrelevant with the threshold voltage of the first thin film transistor T1. The first thin film transistor T1 is a drive thin film transistor, and the second thin film transistor T2 is a mirror thin film transistor. The fifth thin film transistor T5 is located between the power supply voltage Vdd and the first thin film transistor T1. Only when the fifth, the first thin film transistors T5, T1 are activated at the same time, the organic light emitting diode D1 can be driven to emit light. Furthermore, the fifth thin film transistor T5 is controlled by the third scan control signal S3, and the third scan control signal S3 provides high, low alternate voltages according to time sequence to control the activation or deactivation of the fifth thin film transistor T5, and accordingly to control whether the organic light emitting diode D1 emits light or not.

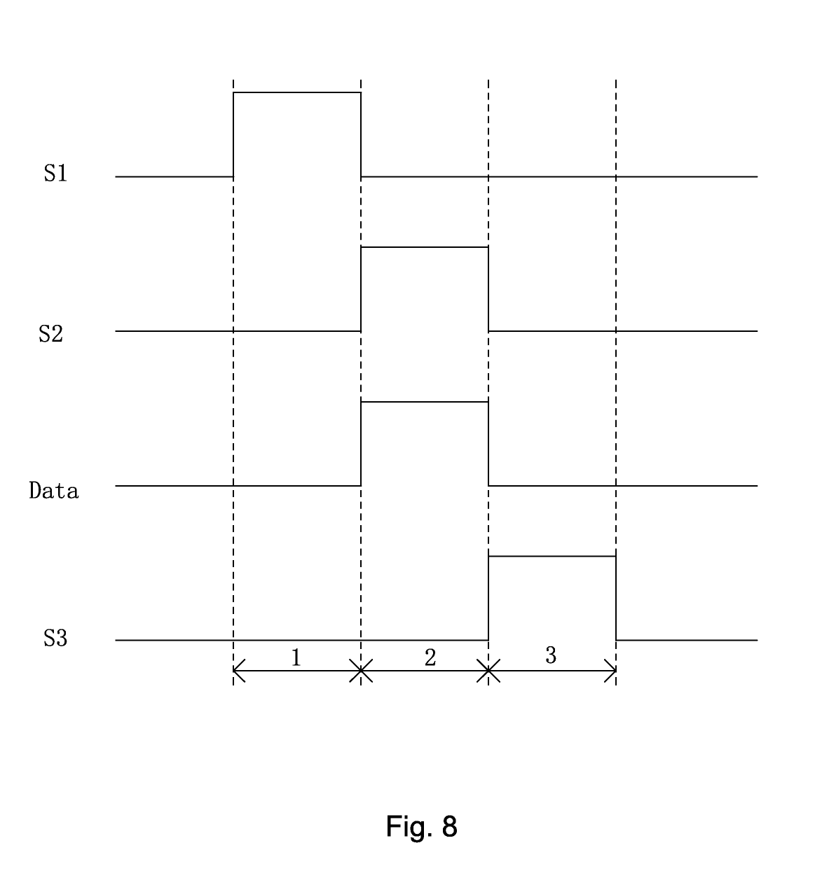

All of the first scan control signal S1, the second scan control signal S2 and the third scan control signal S3 are provided by an external sequence controller. As shown in FIG. 8, the first scan control signal S1, the second scan control signal S2, the third scan control signal S3 and the data signal Data are combined with one another, and correspond to a pre-adjustment stage 1, a current adjustment stage 2 and a drive stage 3 one after another. Specifically, in the pre-adjustment stage 1, the first scan control signal S1 provides high voltage level, and all of the second scan control signal S2, the third scan control signal S3 and the data signal Data provide low voltage level; in the current adjustment stage 2, both the first scan control signal S1 and the third scan control signal S3 provide low voltage level, and both the second scan control signal S2 and the data signal Data provide high voltage level; in the drive stage 3, all of the first scan control signal S1, the second scan control signal S2 and the data signal Data provide low voltage level, and the third scan control signal S3 provides high voltage level.

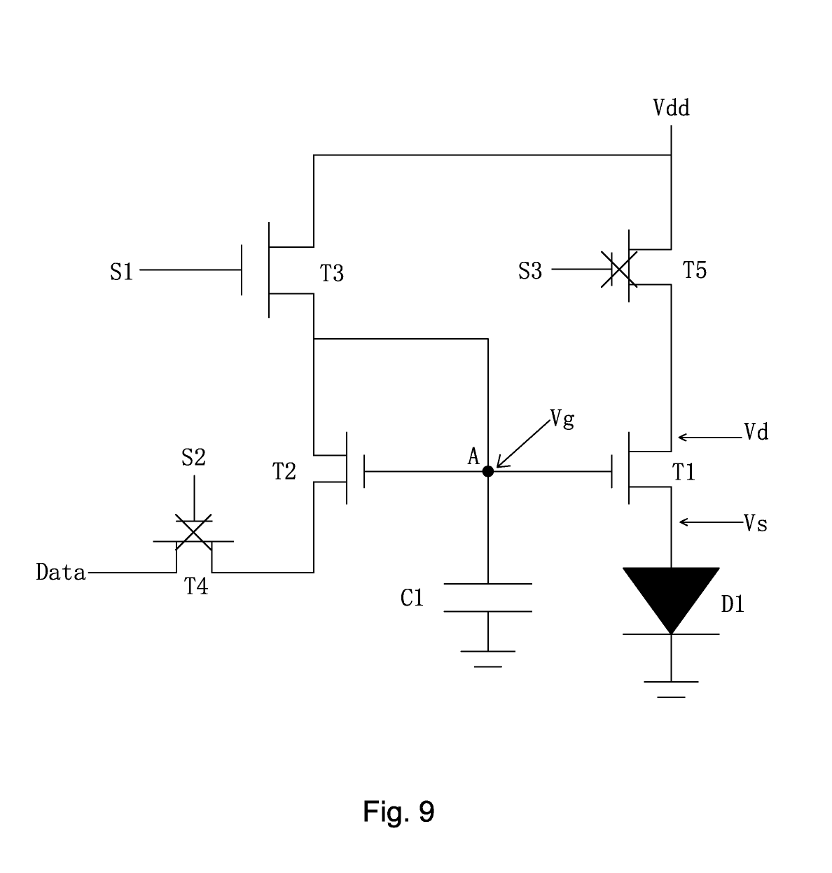

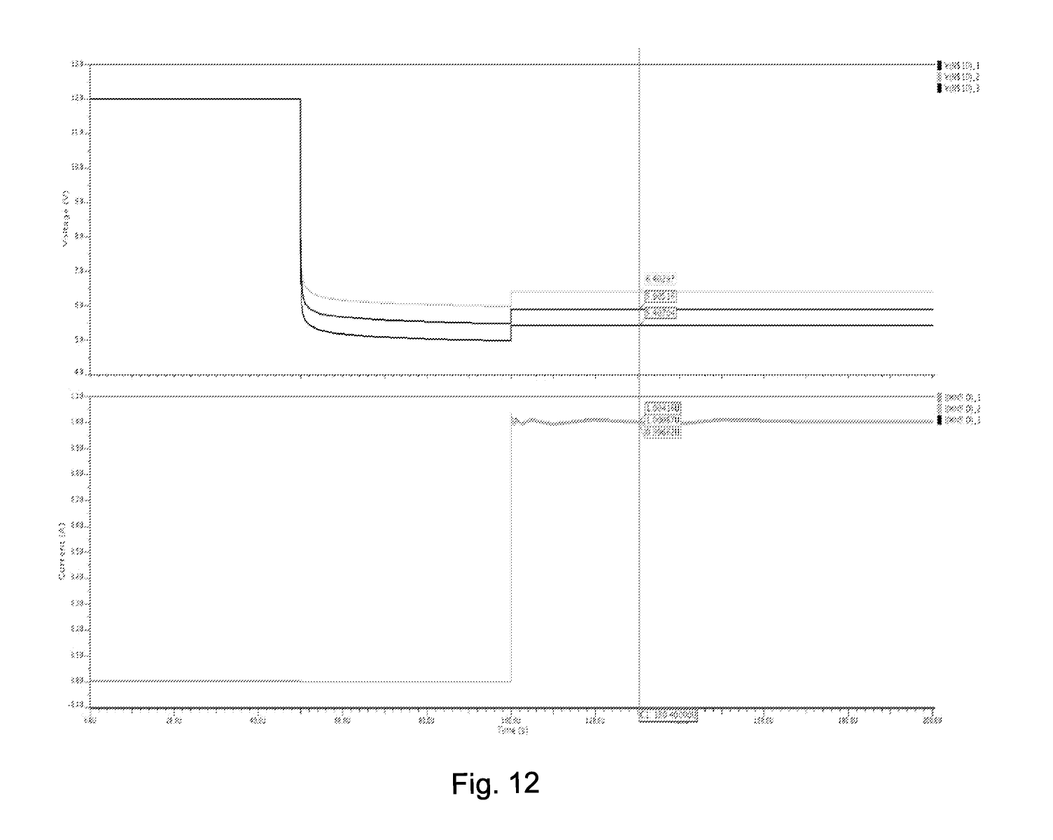

In conjunction with FIG. 9 to FIG. 11, because the third scan control signal S3 provides low voltage level both in the pre-adjustment stage 1 and the current adjustment stage 2, the fifth thin film transistor T5 is deactivated, and merely the first thin film transistor T1 is activated. The organic light emitting diode D1 does not emit light. Because the third scan control signal S3 provides high voltage level in the drive stage 3, both the fifth thin film transistor T5 and the first thin film transistor T1 are activated. The organic light emitting diode D1 emits light. As shown in FIG. 12, in the pre-adjustment stage 1 and the current adjustment stage 2, no current flows through the organic light emitting diode D1; in the drive stage 3, a normal current flows through the organic light emitting diode D1 to avoid the unnecessary irradiance of the organic light emitting diode D1 to reduce the electrical power consumption and improve the display effect of the pictures.

Please refer from FIG. 9 to FIG. 11 in conjunction with FIG. 7 and FIG. 8. The present invention further provides an AMOLED pixel driving method, comprising steps of:

step 1, providing an AMOLED pixel driving circuit utilizing the 5T1C structure as shown in the aforesaid FIG. 7, and the description of the circuit is not repeated here.

All of the first thin film transistor T1, the second thin film transistor T2, the third thin film transistor T3, the fourth thin film transistor T4 and the fifth thin film transistor T5 in the AMOLED pixel driving circuit are Low Temperature Poly-silicon thin film transistors, oxide semiconductor thin film transistors or amorphous silicon thin film transistors. The first thin film transistor T1 and the second thin film transistor T2 are symmetrically located, and widths of channels of the two are similar. Accordingly, the threshold voltages of the first thin film transistor T1 and the second thin film transistor T2 are approximately equal. The first thin film transistor T1 is a drive thin film transistor, and the second thin film transistor T2 is a mirror thin film transistor. The fifth thin film transistor T5 is located between the power supply voltage Vdd and the first thin film transistor T1. Only when the fifth, the first thin film transistors T5, T1 are activated at the same time, the organic light emitting diode D1 can be driven to emit light.

All of the first scan control signal S1, the second scan control signal S2 and the third scan control signal S3 in the AMOLED pixel driving circuit are provided by an external sequence controller.

step 2, referring to FIG. 8, FIG. 9 together, entering a pre-adjustment stage 1.

The first scan control signal S1 provides high voltage level, and the third thin film transistor T3 is activated; both the second scan control signal S2 and the data signal Data provide low voltage level, and the fourth thin film transistor T4 is deactivated; the capacitor C1 is charged to the power supply voltage Vdd, and a gate voltage Vg of the first thin film transistor T1 is raised to the power supply voltage Vdd, and the first thin film transistor T1 is activated; the third scan control signal S3 provides low voltage level, and the fifth thin film transistor T5 is deactivated to stop the connection of the first thin film transistor T1 and the power supply voltage Vdd to make the drain voltage Vd of the first thin film transistor T1 be 0 to control the organic light emitting diode D1 not to emit light and to avoid the unnecessary irradiance of the organic light emitting diode D1 and reduce the electrical power consumption.

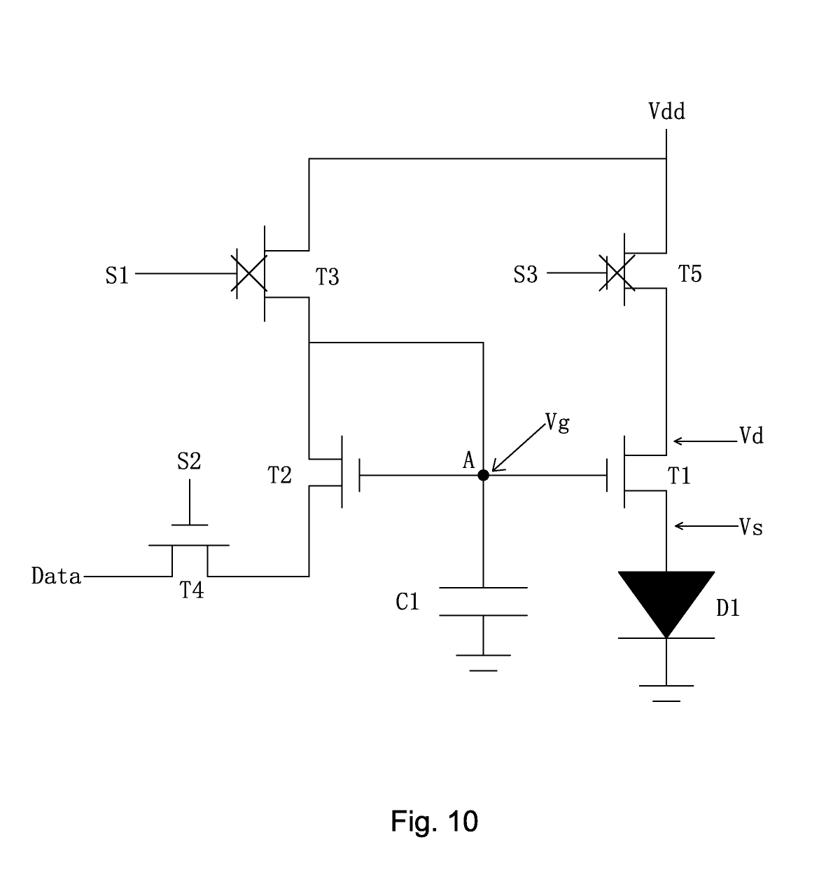

step 3, referring to FIG. 8, FIG. 10 together, entering a current adjustment stage 2.

The first scan control signal S1 provides high voltage level, and the third thin film transistor T3 is activated; both the second scan control signal S2 and the data signal Data provide high voltage level, and the fourth thin film transistor T4 is activated; the capacitor C1 is discharged to V_{Data}+V_{Th2}, and the gate voltage Vg of the first thin film transistor T1 is correspondingly converted to V_{Data}+V_{Th2}, wherein V_{Data} is a voltage provided by the data signal Data, and V_{Th2} is a threshold voltage of the second thin film transistor T2, and the first thin film transistor T1 is activated; the third scan control signal S3 provides low voltage level, and the fifth thin film transistor T5 is deactivated to stop the connection of the first thin film transistor T1 and the power supply voltage Vdd to make the drain voltage Vd of the first thin film transistor T1 be 0 to control the organic light emitting diode D1 not to emit light and to avoid the unnecessary irradiance of the organic light emitting diode D1 and reduce the electrical power consumption.

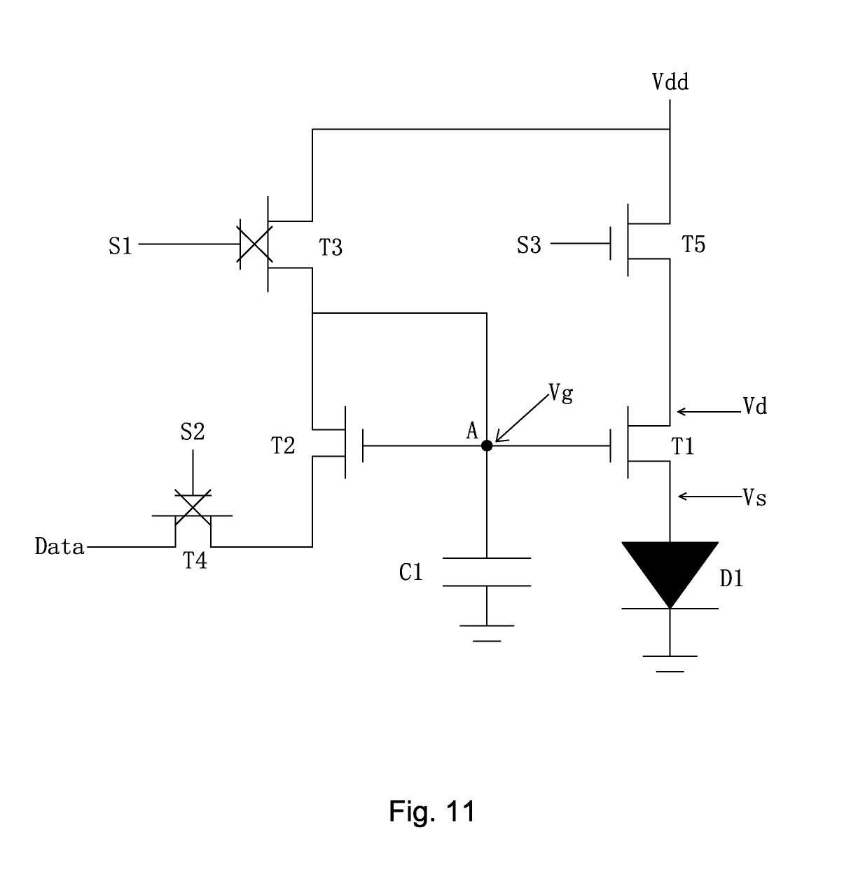

step 4, referring to FIG. 8, FIG. 11 together, entering a drive stage 3.

All of the first scan control signal S1, the second scan control signal S2 and the data signal Data provide low voltage level, and the third, the fourth thin film transistors T3, T4 are deactivated; under the function of the capacitor C1, the gate voltage Vg of the first thin film transistor T1 remains to be V_{Data}+V_{Th2}, and the first thin film transistor T1 is activated; the third scan control signal S3 provides high voltage level, and the fifth thin film transistor T5 is activated to conduct the connection of the first thin film transistor T1 and the power supply voltage Vdd to make the drain voltage Vd of the first thin film transistor T1 be Vdd to control the organic light emitting diode D1 to normally emit light.

The first thin film transistor T1 and the second thin film transistor T2 are symmetrically located, and widths of channels of the two are similar. Accordingly, the threshold voltages of the first thin film transistor T1 and the second thin film transistor T2 are approximately equal. Therefore, V_{Th1}=V_{Th2}, wherein V_{Th1} is the threshold voltage of the first thin film transistor T1. In the drive stage 3, the gate voltage Vg of the first thin film transistor T1 is: Vg=V_{Data}+V_{Th2}, and the source voltage Vs of the first thin film transistor T1 is: Vs=V_{OLED}, wherein V_{OLED} is the threshold voltage of the organic light emitting diode D1. According to the current property equation of the thin film transistor in this field, the current I_{OLED} flowing through the organic light emitting diode D1 is:

$$\begin{matrix}{I}_{OLED} = {K ( Vg - Vs - {V}_{Th 1} )}^{2} \\ = {K ( {V}_{Data} + {V}_{Th 2} - {V}_{OLED} - {V}_{Th 1} )}^{2} \\ = {K ( {V}_{Data} - {V}_{OLED} )}^{2}\end{matrix}$$

wherein K is the structure parameter of the thin film transistor. As regarding the thin film transistors having the same structure, K is relatively stable.

As known from the equation, the threshold voltage of the second thin film transistor T2 compensates the threshold voltage of the first thin film transistor T1 to make the current flowing through the organic light emitting diode D1 irrelevant with the threshold voltage of the first thin film transistor T1.

Please refer to FIG. 12, in the pre-adjustment stage 1 and the current adjustment stage 2, no current flows through the organic light emitting diode D1; in the drive stage 3, a normal current flows through the organic light emitting diode D1 to avoid the unnecessary irradiance of the organic light emitting diode D1 to reduce the electrical power consumption and improve the display effect of the pictures.

In conclusion, an AMOLED pixel driving circuit and pixel driving method provided by the present invention, by symmetrically locating the first thin film transistor and the second thin film transistor, of which the threshold voltages are equal, realizes the function of compensating the threshold voltage of the drive thin film transistor to make a current flowing through the organic light emitting diode irrelevant with the threshold voltage of the first thin film transistor; the fifth thin film transistor is located between the power supply voltage and the first thin film transistor, i.e. the drive thin film transistor, and the third scan control signal is employed to control the fifth thin film transistor to be activated only in the drive stage according to the time sequence. Thus, the organic light emitting diode is controlled to emit light only in the drive stage to avoid the unnecessary irradiance of the organic light emitting diode to reduce the electrical power consumption and improve the display effect of the pictures.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. An AMOLED pixel driving circuit, comprising: a first thin film transistor, a second thin film transistor, a third thin film transistor, a fourth thin film transistor, a fifth thin film transistor, a capacitor and an organic light emitting diode;
a gate of the first thin film transistor is electrically coupled to a gate of the second thin film transistor via a first node, and a drain is electrically coupled to a drain of the fifth thin film transistor, and a source is electrically coupled to an anode of the organic light emitting diode;
the gate of the second thin film transistor is electrically coupled to the gate of the first thin film transistor via the first node, and a drain is electrically coupled to a drain of the third thin film transistor and the first node, and a source is electrically coupled to a drain of the fourth thin film transistor;
a gate of the third thin film transistor is electrically coupled to a first scan control signal, and a source is electrically coupled to a power supply voltage, and the drain is electrically coupled to the drain of the second thin film transistor and the first node;
a gate of the fourth thin film transistor is electrically coupled to a second scan control signal, and a source is electrically coupled to a data signal, and a drain is electrically coupled to the source of the second thin film transistor;
a gate of the fifth thin film transistor is electrically coupled to a third scan control signal, and a source is electrically coupled to the power supply voltage and a drain is electrically coupled to the drain of the first thin film transistor;
one end of the capacitor is electrically coupled to the first node, and the other end is grounded;
the anode of the organic light emitting diode is electrically coupled to the source of the first thin film transistor, and a cathode is grounded;
the first thin film transistor is a drive thin film transistor, and a threshold voltage thereof is equal to a threshold voltage of the second thin film transistor;
the third scan control signal provides high, low alternate voltages according to time sequence to control whether the organic light emitting diode emits light or not.

2. The AMOLED pixel driving circuit according to claim 1, wherein all of the first thin film transistor, the second thin film transistor, the third thin film transistor, the fourth thin film transistor and the fifth thin film transistor are Low Temperature Poly-silicon thin film transistors, oxide semiconductor thin film transistors or amorphous silicon thin film transistors.

3. The AMOLED pixel driving circuit according to claim 1, wherein the first thin film transistor and the second thin film transistor are symmetrically located, and widths of channels of the two are similar.

4. The AMOLED pixel driving circuit according to claim 1, wherein all of the first scan control signal, the second scan control signal and the third scan control signal are provided by an external sequence controller.

5. The AMOLED pixel driving circuit according to claim 1, wherein the first scan control signal, the second scan control signal, the third scan control signal and the data signal are combined with one another, and correspond to a pre-adjustment stage, a current adjustment stage and a drive stage one after another;
the third scan control signal provides low voltage level in both the pre-adjustment stage and the current adjustment stage to control the organic light emitting diode not to emit light; the third scan control signal provides high voltage level in the drive stage to control the organic light emitting diode to emit light.

6. The AMOLED pixel driving circuit according to claim 5, wherein,
in the pre-adjustment stage, the first scan control signal provides high voltage level, and all of the second scan control signal, the third scan control signal and the data signal provide low voltage level;
in the current adjustment stage, both the first scan control signal and the third scan control signal provide low voltage level, and both the second scan control signal and the data signal provide high voltage level;
in the drive stage, all of the first scan control signal, the second scan control signal and the data signal provide low voltage level, and the third scan control signal provides high voltage level.

7. An AMOLED pixel driving circuit, comprising: a first thin film transistor, a second thin film transistor, a third thin film transistor, a fourth thin film transistor, a fifth thin film transistor, a capacitor and an organic light emitting diode;
a gate of the first thin film transistor is electrically coupled to a gate of the second thin film transistor via a first node, and a drain is electrically coupled to a drain of the fifth thin film transistor, and a source is electrically coupled to an anode of the organic light emitting diode;
the gate of the second thin film transistor is electrically coupled to the gate of the first thin film transistor via the first node, and a drain is electrically coupled to a drain of the third thin film transistor and the first node, and a source is electrically coupled to a drain of the fourth thin film transistor;
a gate of the third thin film transistor is electrically coupled to a first scan control signal, and a source is electrically coupled to a power supply voltage, and the drain is electrically coupled to the drain of the second thin film transistor and the first node;
a gate of the fourth thin film transistor is electrically coupled to a second scan control signal, and a source is electrically coupled to a data signal, and a drain is electrically coupled to the source of the second thin film transistor;
a gate of the fifth thin film transistor is electrically coupled to a third scan control signal, and a source is electrically coupled to the power supply voltage and a drain is electrically coupled to the drain of the first thin film transistor;
one end of the capacitor is electrically coupled to the first node, and the other end is grounded;
the anode of the organic light emitting diode is electrically coupled to the source of the first thin film transistor, and a cathode is grounded;
the first thin film transistor is a drive thin film transistor, and a threshold voltage thereof is equal to a threshold voltage of the second thin film transistor;
the third scan control signal provides high, low alternate voltages according to time sequence to control whether the organic light emitting diode emits light or not;
wherein all of the first thin film transistor, the second thin film transistor, the third thin film transistor, the fourth thin film transistor and the fifth thin film transistor are Low Temperature Poly-silicon thin film transistors, oxide semiconductor thin film transistors or amorphous silicon thin film transistors;
wherein the first thin film transistor and the second thin film transistor are symmetrically located, and widths of channels of the two are similar.

8. The AMOLED pixel driving circuit according to claim 7, wherein all of the first scan control signal, the second scan control signal and the third scan control signal are provided by an external sequence controller.

9. The AMOLED pixel driving circuit according to claim 7, wherein the first scan control signal, the second scan control signal, the third scan control signal and the data signal are combined with one another, and correspond to a pre-adjustment stage, a current adjustment stage and a drive stage one after another;
the third scan control signal provides low voltage level in both the pre-adjustment stage and the current adjustment stage to control the organic light emitting diode not to emit light; the third scan control signal provides high voltage level in the drive stage to control the organic light emitting diode to emit light.

10. The AMOLED pixel driving circuit according to claim 9, wherein,
in the pre-adjustment stage, the first scan control signal provides high voltage level, and all of the second scan control signal, the third scan control signal and the data signal provide low voltage level;
in the current adjustment stage, both the first scan control signal and the third scan control signal provide low voltage level, and both the second scan control signal and the data signal provide high voltage level;
in the drive stage, all of the first scan control signal, the second scan control signal and the data signal provide low voltage level, and the third scan control signal provides high voltage level.

11. An AMOLED pixel driving method, comprising steps of:
step 1, providing an AMOLED pixel driving circuit;
the AMOLED pixel driving circuit comprises: a first thin film transistor, a second thin film transistor, a third thin film transistor, a fourth thin film transistor, a fifth thin film transistor, a capacitor and an organic light emitting diode;
a gate of the first thin film transistor is electrically coupled to a gate of the second thin film transistor via a first node, and a drain is electrically coupled to a drain of the fifth thin film transistor, and a source is electrically coupled to an anode of the organic light emitting diode;
the gate of the second thin film transistor is electrically coupled to the gate of the first thin film transistor via the first node, and a drain is electrically coupled to a drain of the third thin film transistor and the first node, and a source is electrically coupled to a drain of the fourth thin film transistor;
a gate of the third thin film transistor is electrically coupled to a first scan control signal, and a source is electrically coupled to a power supply voltage, and the drain is electrically coupled to the drain of the second thin film transistor and the first node;
a gate of the fourth thin film transistor is electrically coupled to a second scan control signal, and a source is electrically coupled to a data signal, and a drain is electrically coupled to the source of the second thin film transistor;
a gate of the fifth thin film transistor is electrically coupled to a third scan control signal, and a source is electrically coupled to the power supply voltage and a drain is electrically coupled to the drain of the first thin film transistor;
one end of the capacitor is electrically coupled to the first node, and the other end is grounded;
the anode of the organic light emitting diode is electrically coupled to the source of the first thin film transistor, and a cathode is grounded;
the first thin film transistor is a drive thin film transistor, and a threshold voltage thereof is equal to a threshold voltage of the second thin film transistor;
step 2, entering a pre-adjustment stage;
the first scan control signal provides high voltage level, and both the second scan control signal and the data signal provide low voltage level, and the capacitor is charged to the power supply voltage, and a gate voltage of the first thin film transistor is raised to the power supply voltage, and the first thin film transistor is activated, and the third scan control signal provides low voltage level, and the fifth thin film transistor is deactivated to control the organic light emitting diode not to emit light;
step 3, entering a current adjustment stage;
the first scan control signal provides low voltage level, and both the second scan control signal and the data signal provide high voltage level, and the capacitor is discharged to V_{Data}+V_{Th2}, and the gate voltage of the first thin film transistor is correspondingly converted to V_{Data}+V_{Th2}, wherein V_{Data} is a voltage provided by the data signal, and V_{Th2} is a threshold voltage of the second thin film transistor, and the first thin film transistor is activated, and the third scan control signal provides low voltage level, and the fifth thin film transistor is deactivated to control the organic light emitting diode not to emit light;
step 4, entering a drive stage;
all of the first scan control signal, the second scan control signal and the data signal provide low voltage level, and the gate voltage of the first thin film transistor remains to be V_{Data}+V_{Th2}, and the first thin film transistor is activated, and the third scan control signal provides high voltage level, and the fifth thin film transistor is activated to control the organic light emitting diode to emit light, and the threshold voltage of the second thin film transistor compensates the threshold voltage of the first thin film transistor to make a current flowing through the organic light emitting diode irrelevant with the threshold voltage of the first thin film transistor.

12. The AMOLED pixel driving method according to claim 11, wherein all of the first thin film transistor, the second thin film transistor, the third thin film transistor, the fourth thin film transistor and the fifth thin film transistor are Low Temperature Poly-silicon thin film transistors, oxide semiconductor thin film transistors or amorphous silicon thin film transistors.

13. The AMOLED pixel driving method according to claim 11, wherein all of the first scan control signal, the second scan control signal and the third scan control signal are provided by an external sequence controller.

14. The AMOLED pixel driving method according to claim 11, wherein the first thin film transistor and the second thin film transistor are symmetrically located.
